(19) United States
(12) Patent Application Publication
(10) Pub. No.: US 2026/0189987 A1
(43) Pub. Date: Jul. 2, 2026

(54) Network Switching Method, and Electronic Device and Non-Transitory Readable Storage Medium

(71) Applicant: VIVO MOBILE COMMUNICATION CO.,LTD., Dongguan (CN)

(72) Inventors: Gang Wang, Dongguan (CN); Jiangmin Huang, Dongguan (CN)

(21) Appl. No.: 19/542,730

(22) Filed: Feb. 18, 2026

Related U.S. Application Data
(63) Continuation of application No. PCT/CN2024/113692, filed on Aug. 21, 2024.

(30) Foreign Application Priority Data
Aug. 23, 2023 (CN) 202311071184.6

(51) Int. Cl. H04W 36/00; H04W 36/14

(52) U.S. Cl. CPC H04W 36/0011; H04W 36/14

(57) ABSTRACT

A network switching method includes determining, during transmission of a first voice service corresponding to a first call by an electronic device through a first network, whether switching between a VoWi-Fi service and a VoNR service is supported, where the first network is a Wi-Fi network or a 5G network; switching to a second network when the switching between the VoWi-Fi service and the VoNR service is supported, and transmitting the first voice service through the second network, where the second network is the Wi-Fi network or the 5G network, and the first network is different from the second network; and switching to a third network when the switching between the VoWi-Fi service and the VoNR service is not supported, and transmitting the first voice service through the third network. The third network is different from the first network, and the third network is different from the second network.

### CROSS-REFERENCE TO RELATED APPLICATIONS

This application is a Bypass Continuation Application of International Patent Application No. PCT/CN2024/113692 filed August 21, 2024, and claims priority to Chinese Patent Application No. 202311071184.6 filed August 23, 2023, the disclosures of which are hereby incorporated by reference in their entireties.

### FIELD OF THE INVENTION

This application relates to the field of communication technologies, and in particular, to a network switching method, an electronic device, and a non-transitory readable storage medium.

### DESCRIPTION OF RELATED ART

A voice call service carried in a fifth generation mobile communication technology (5G) is referred to as Voice over New Radio (VoNR) service. An electronic device may maintain a stable and high-speed data connection during transmitting the VoNR service.

### SUMMARY OF THE INVENTION

According to a first aspect, an embodiment of this application provides a network switching method. The method includes: determining, during transmission of a first voice service corresponding to a first call by an electronic device through a first network, whether switching between a VoWi-Fi service and a VoNR service is supported, where the first network is a Wi-Fi network or a 5G network; switching to a second network when the switching between the VoWi-Fi service and the VoNR service is supported, and transmitting the first voice service through the second network, where the second network is the Wi-Fi network or the 5G network, and the first network is different from the second network; and switching to a third network when the switching between the VoWi-Fi service and the VoNR service is not supported, and transmitting the first voice service through the third network, where the third network is different from the first network, and the third network is different from the second network.

According to a second aspect, an embodiment of this application provides a network switching apparatus. The apparatus includes a determining module, a switching module, and a transmission module. The determining module is configured to determine, during transmission of a first voice service corresponding to a first call by an electronic device through a first network, whether switching between a VoWi-Fi service and a VoNR service is supported, where the first network is a Wi-Fi network or a 5G network. The switching module is configured to switch to a second network when the determining module determines that the switching between the VoWi-Fi service and the VoNR service is supported. The transmission module is configured to transmit the first voice service through the second network after the switching module switches to the second network, the second network is the Wi-Fi network or the 5G network, and the first network is different from the second network. The switching module is further configured to switch to a third network when the determining module determines that the switching between the VoWi-Fi service and the VoNR service is not supported. The transmission module is further configured to transmit the first voice service through the third network after the switching module switches to the second network, the third network is different from the first network, and the third network is different from the second network.

According to a third aspect, an embodiment of this application provides an electronic device. The electronic device includes a processor and a memory. The memory stores a program or an instruction executable on the processor. When the program or the instruction is executed by the processor, the steps of the method in the first aspect are implemented.

According to a fourth aspect, an embodiment of this application provides a non-transitory readable storage medium. The non-transitory readable storage medium stores a program or an instruction. When the program or the instruction is executed by a processor, the steps of the method in the first aspect are implemented.

According to a fifth aspect, an embodiment of this application provides a chip. The chip includes a processor and a communication interface. The communication interface is coupled to the processor. The processor is configured to execute a program or an instruction, to implement the method in the first aspect.

According to a sixth aspect, an embodiment of this application provides a computer program product. The program product is stored in a non-transitory storage medium. The program product is executed by at least one processor to implement the method in the first aspect.

### BRIEF DESCRIPTION OF THE DRAWINGS

FIG. 1 is a schematic flowchart I of a network switching method according to an embodiment of this application;

FIG. 2 is a schematic diagram of an example of a call setting interface according to an embodiment of this application;

FIG. 3 is a schematic flowchart II of a network switching method according to an embodiment of this application;

FIG. 4 is a schematic flowchart III of a network switching method according to an embodiment of this application;

FIG. 5 is a schematic flowchart IV of a network switching method according to an embodiment of this application;

FIG. 6 is a schematic structural diagram I of a network switching apparatus according to an embodiment of this application;

FIG. 7 is a schematic structural diagram II of a network switching apparatus according to an embodiment of this application;

FIG. 8 is a schematic diagram I of a hardware structure of an electronic device according to an embodiment of this application; and

FIG. 9 is a schematic diagram II of a hardware structure of an electronic device according to an embodiment of this application.

### DESCRIPTION OF THE INVENTION

Technical solutions in embodiments of this application are clearly described below with reference to the accompanying drawings in embodiments of this application. Apparently, the described embodiments are merely some rather than all of embodiments of this application. All other embodiments obtained by a person skilled in the art based on embodiments of this application fall within the protection scope of this application.

Terms "first", "second", and the like in the specification and the claims of this application are used to distinguish between similar objects, rather than describe a specific sequence or order. It should be understood that the terms used in this way may be transposed where appropriate, so that embodiments of this application described herein may be implemented in an order different from those illustrated or described herein. In addition, the objects distinguished by "first", "second", and the like are generally of the same class and do not limit a quantity of objects. For example, one or more first objects may be arranged. In addition, in the specification and the claims, "and/or" indicates at least one of connected objects, and the character "/" generally indicates an "or" relationship between associated objects.

A network switching method in embodiments of this application is described below with reference to the accompany drawings through some embodiments and application scenarios thereof.

The network switching method in embodiments of this application may be applied to a call scenario of an electronic device.

Currently, coverage of a VoNR is still not high, and some imperfections still exist in a call technology of the VoNR. A voice over wireless-fidelity (VoWi-Fi) service has been around for a relatively long time, and has a relatively mature technology. Although the two technologies have been around for a while, switching between the VoNR and the VoWi-Fi has not been discussed much. Although related standards are described in terms of some network architectures, no clear solution is formed in an actual network application. Currently, deployment of a 5G standalone SA network remains incomplete. Therefore, in SA commercial networks of many operators, mutual switching between the VoNR and the VoWi-Fi is temporarily not supported. Therefore, in an actual application, while the electronic device registers the VoWi-Fi in an SA network and establishes a call, because coverage of a Wi-Fi network is limited, the electronic device attempts to switch from the wireless fidelity (Wi-Fi) network to a 5G network when the electronic device moves to an area with weak coverage of the Wi-Fi network or no coverage of the Wi-Fi network. In this case, if the switching between the VoWi-Fi and the VoNR is not supported, network switching fails, and transmission of a current call service is interrupted. Alternatively, while the electronic device performs a VoNR call in the SA network, the electronic device pre-connects to the Wi-Fi network when the electronic device moves to a Wi-Fi network environment. In this case, if switching between the VoWi-Fi and the VoNR is not supported, network switching fails, and transmission of a current call service is interrupted. In this way, the electronic device has relatively low call continuity.

In the network switching method and apparatus, the electronic device, and the non-transitory storage medium provided in embodiments of this application, the electronic device may determine, during transmission of a first voice service corresponding to a first call by the electronic device through a first network, whether the switching between the VoWi-Fi service and the VoNR service is supported. As a result, when a determining result is that the switching between the VoWi-Fi service and the VoNR service is supported, the electronic device may switch from the Wi-Fi network to the 5G network or switch from the 5G network to the Wi-Fi network. However, when the determining result is that the switching between the VoWi-Fi service and the VoNR service is not supported, the electronic device may switch from the Wi-Fi network or the 5G network to another third network. It is avoided that during transmission of the first voice service by the electronic device through the Wi-Fi network or the 5G network and when the electronic device needs to switch a network and attempts to switch between the first network and the second network, a problem of call interruption caused by failed network switching of the electronic device is caused because the electronic device does not support the switching between the VoWi-Fi service and the VoNR service. Therefore, flexibility of transmitting a voice service by the electronic device is improved, thereby improving call continuity of the electronic device.

For example, a voice service carried in the Wi-Fi network is referred to as the VoWi-Fi service. A voice service carried in the 5G network is referred to as the VoNR service. A voice service carried in a 4G network is referred to as a voice over long-term evolution (VoLTE) service.

For example, that the electronic device determines whether the switching between the VoWi-Fi service and the VoNR service is supported may be understood as that the electronic device determines whether switching between the Wi-Fi network and the 5G network is supported.

An execution body of the network switching method provided in embodiments of this application may be a network switching apparatus. The network switching apparatus may be an electronic device, or a functional module or entity in the electronic device. The technical solution of embodiments of this application is described in detail below by using the electronic device as an example.

An embodiment of this application provides a network switching method. FIG. 1 is a flowchart of a network switching method according to an embodiment of this application. The method may be applied to an electronic device. As shown in FIG. 1, the network switching method provided in this embodiment of this application may include step 201 and step 202, or step 201 to step 203 below.

Step 201: An electronic device determines, during transmission of a first voice service corresponding to a first call by the electronic device through a first network, whether switching between a VoWi-Fi service and a VoNR service is supported.

The foregoing first network is a Wi-Fi network or a 5G network.

In some embodiments of this application, the electronic device may determine whether the switching between the VoWi-Fi service and the VoNR service is supported in advance, and store a determining result. Therefore, the electronic device may directly determine, during transmission of the first voice service corresponding to the first call through the first network, whether the switching between the VoWi-Fi service and the VoNR service is supported based on a determining result.

In some embodiments of this application, "an electronic device determines whether switching between a VoWi-Fi service and a VoNR service is supported" in step 201 above may be implemented through step 201a below.

Step 201a: The electronic device determines, based on first information, whether the switching between the VoWi-Fi service and the VoNR service is supported.

The foregoing first information is any one of the following: relevant information of an access network discovery and selection function (ANDSF) network element address, first operator information of an operator that supports the switching between the VoWi-Fi service and the VoNR service, and first cell information of a cell that does not support the switching between the VoWi-Fi service and the VoNR service.

In some embodiments of this application, the foregoing first information may be an operator list. The operator list includes the first operator information of the operator that supports the switching between the VoWi-Fi service and the VoNR service. The first operator information may be an operator identifier.

In some embodiments of this application, the foregoing first information may be a cell list. The cell list includes first cell information of the cell that does not support the switching between the VoWi-Fi service and the VoNR service.

In some embodiments of this application, the foregoing first cell information may include at least one of the following: a physical cell identifier ID, a cell ID, a global cell identification code CGI, a first network identifier broadcast in the first cell, a tracking area identifier to which the first cell belongs, or the like, which is not limited in this embodiment of this application.

In a first possible implementation:

in some embodiments of this application, the foregoing first information includes the relevant information of the ANDSF network element address. Before step 201a above, the network switching method provided in this embodiment of this application further includes step 301 below. In addition, step 201a above may be implemented through step 201a1 or step 201a2 below.

Step 301: Query a first query object for the ANDSF network element address, and use a query result as the first information.

The foregoing first query object includes at least one of the following: a universal integrated circuit card (UICC) used by the electronic device, the electronic device, a protocol data unit PDU session establishment acceptance message replied by a network, a domain name server (DNS), or a dynamic host configuration protocol (DHCP) server.

The foregoing relevant information of the ANDSF network element address includes a query result.

It may be understood that if the switching between the VoWi-Fi service and the VoNR service is supported, the electronic device may have deployment of a related ANDSF network element. Therefore, whether the switching between the VoWi-Fi service and the VoNR service is supported can be determined by querying the first query object for the ANDSF network element address.

For example, the electronic device may check whether an inserted UICC includes the ANDSF network element address. Alternatively, the electronic device may check whether the ANDSF network element address is built in. Alternatively, the electronic device may check whether a protocol data unit (PDU) session establishment acceptance message replied by the network, namely, a PDU Session Establishment Accept message, includes the ANDSF network element address. Alternatively, the electronic device may search for an ANDSF network element address through DNS query or DHCP query, and use the query result as the first information.

In some embodiments of this application, the DHCP is a network protocol of a local area network, and works through a user datagram protocol (UDP). Through the DHCP protocol, a DHCP server may automatically allocate an IP address to a DHCP client that logs in to a TCP/IP network.

In some embodiments of this application, the electronic device may query the first query object for the ANDSF network element address in advance, and save a query result. Therefore, the electronic device may directly determine, during transmission of the first voice service corresponding to the first call through the first network, whether the switching between the VoWi-Fi service and the VoNR service is supported based on a query result.

Step 201a1: The electronic device determines that the switching between the VoWi-Fi service and the VoNR service is supported if the query result indicates that the ANDSF network element address is found in the first query object.

It may be understood that if the switching between the VoWi-Fi service and the VoNR service is supported, a related ANDSF network element may be deployed in the first query object. Therefore, when finding the ANDSF network element address in the first query object, the electronic device may determine that the switching between the VoWi-Fi service and the VoNR service is supported.

Step 201a2: The electronic device determines that the switching between the VoWi-Fi service and the VoNR service is not supported if the query result indicates that the ANDSF network element address is not found in the first query object.

It may be understood that if the switching between the VoWi-Fi service and the VoNR service is not supported, no related ANDSF network element is deployed in the first query object. Therefore, when the electronic device does not find the ANDSF network element address in the first query object, the electronic device can determine that the switching between the VoWi-Fi service and the VoNR service is not supported.

In this way, the first query object is queried for whether the ANDSF network element address exists, so as to determine whether the switching between the VoWi-Fi service and the VoNR service is supported based on the query result, thereby improving flexibility of determining, by the electronic device, whether the switching between the VoWi-Fi service and the VoNR service is supported.

In a second possible implementation:

in some embodiments of this application, the foregoing first information includes the first operator information. Step 201a above may be implemented through step 201a3 or step 201a4 below.

Step 201a3: The electronic device determines that the switching between the VoWi-Fi service and the VoNR service is supported when the first information indicates that a first operator currently used by the electronic device is the operator that supports the switching between the VoWi-Fi service and the VoNR service.

In some embodiments of this application, the electronic device may obtain the foregoing first operator information during transmission of the first voice service corresponding to the first call by the electronic device through the first network, and detect whether the first operator information includes the operator information of the first operator currently used by the electronic device. In this way, it is determined that the switching between the VoWi-Fi service and the VoNR service is supported when the first operator information includes the operator information of the first operator currently used by the electronic device. In other words, the foregoing first information indicates that the first operator currently used by the electronic device is an operator that supports the switching between the VoWi-Fi service and the VoNR service.

Step 201a4: The electronic device determines that the switching between the VoWi-Fi service and the VoNR service is not supported when the first information indicates that a first operator currently used by the electronic device is not an operator that supports the switching between the VoWi-Fi service and the VoNR service.

In some embodiments of this application, the electronic device may obtain the foregoing first operator information during transmission of the first voice service corresponding to the first call by the electronic device through the first network, and detect whether the first operator information includes the operator information of the first operator currently used by the electronic device. In this way, it is determined that the switching between the VoWi-Fi service and the VoNR service is not supported when the first operator information does not include the operator information of the first operator currently used by the electronic device. In other words, the foregoing first information indicates that the first operator currently used by the electronic device is not an operator that supports the switching between the VoWi-Fi service and the VoNR service.

In some embodiments of this application, the electronic device may obtain the foregoing first operator information in advance, determine whether the switching between the VoWi-Fi service and the VoNR service is supported based on the first operator information and the operator information of the operator currently used by the electronic device, and store the result. Then, the electronic device may directly determine, during transmission of the first voice service corresponding to the first call by the electronic device through the first network, whether the switching between the VoWi-Fi service and the VoNR service is supported based on the foregoing result.

In this way, the electronic device may determine, based on the first operator information, whether the switching between the VoWi-Fi service and the VoNR service is supported. Therefore, flexibility and diversity of determining, by the electronic device, whether the switching between the VoWi-Fi service and the VoNR service is supported are improved.

In a third possible implementation:

in some embodiments of this application, the foregoing first information includes the first cell information. Step 201a above may be implemented through step 201a5 or step 201a6 below.

Step 201a5: The electronic device determines that the switching between the VoWi-Fi service and the VoNR service is supported when the first information indicates that the first cell currently camped on by the electronic device is not a cell that does not support the switching between the VoWi-Fi service and the VoNR service.

In some embodiments of this application, the electronic device may obtain the foregoing first cell information during transmission of the first voice service corresponding to the first call by the electronic device through the first network, and detect whether the first cell information includes the cell information of the first cell currently camped on by the electronic device. In this way, it is determined that the switching between the VoWi-Fi service and the VoNR service is supported when the first cell information does not include the cell information of the first cell currently camped on by the electronic device. In other words, the foregoing first information indicates that the first cell currently camped on by the electronic device is not a cell that does not support the switching between the VoWi-Fi service and the VoNR service.

Step 201a6: The electronic device determines that the switching between the VoWi-Fi service and the VoNR service is not supported when the first information indicates that the first cell currently camped on by the electronic device is the cell that does not support the switching between the VoWi-Fi service and the VoNR service.

In some embodiments of this application, the electronic device may obtain the foregoing first cell information during transmission of the first voice service corresponding to the first call by the electronic device through the first network, and detect whether the first cell information includes the cell information of the first cell currently camped on by the electronic device. In this way, it is determined that the switching between the VoWi-Fi service and the VoNR service is not supported when the first cell information includes the cell information of the first cell currently camped on by the electronic device. In other words, the foregoing first information indicates that the first cell currently camped on by the electronic device is the cell that does not support the switching between the VoWi-Fi service and the VoNR service.

In this way, the electronic device can determine, based on the first cell information, whether the switching between the VoWi-Fi service and the VoNR service is supported. Therefore, flexibility and diversity of determining, by the electronic device, whether the switching between the VoWi-Fi service and the VoNR service is supported are improved.

In a fourth possible implementation:

in some embodiments of this application, the foregoing first information includes the first operator information and the first cell information. Step 201a above may be implemented through step 201a7, step 201a8, or step 201a9 below.

Step 201a7: The electronic device determines that the switching between the VoWi-Fi service and the VoNR service is supported when the first information indicates that the first cell currently camped on by the electronic device is not a cell that does not support the switching between the VoWi-Fi service and the VoNR service.

In some embodiments of this application, when the first information includes the first operator information and the first cell information, the electronic device may determine, based on whether the first cell currently camped on by the electronic device is the cell that does not support the switching between the VoWi-Fi service and the VoNR service, whether the electronic device supports the switching between the VoWi-Fi service and the VoNR service.

For example, when the foregoing first information indicates that the first cell currently camped on by the electronic device is not the cell that does not support the switching between the VoWi-Fi service and the VoNR service and the first operator currently used by the electronic device is an operator that supports the switching between the VoWi-Fi service and the VoNR service, the electronic device determines that the switching between the VoWi-Fi service and the VoNR service is supported.

For example, when the foregoing first information indicates that the first cell currently camped on by the electronic device is not the cell that does not support the switching between the VoWi-Fi service and the VoNR service and the first operator currently used by the electronic device is not the operator that supports the switching between the VoWi-Fi service and the VoNR service, the electronic device determines that the switching between the VoWi-Fi service and the VoNR service is supported.

In some embodiments of this application, the electronic device may obtain the foregoing first operator information and the first cell information during transmission of the first voice service corresponding to the first call by the electronic device through the first network, detect whether the first operator information includes operator information of a first operator currently used by the electronic device, and detect whether the first cell information includes cell information of a first cell currently camped on by the electronic device. In this way, it is determined whether the switching between the VoWi-Fi service and the VoNR service is determined based on a detection result.

For example, when the detection result is that the first cell currently camped on by the electronic device is not the cell that does not support the switching between the VoWi-Fi service and the VoNR service and the first operator currently used by the electronic device is the operator that supports the switching between the VoWi-Fi service and the VoNR service, the electronic device determines that the switching between the VoWi-Fi service and the VoNR service is supported.

For example, when the detection result is that the first cell currently camped on by the electronic device is not the cell that does not support the switching between the VoWi-Fi service and the VoNR service and the first operator currently used by the electronic device is not the operator that supports the switching between the VoWi-Fi service and the VoNR service, the electronic device determines that the switching between the VoWi-Fi service and the VoNR service is supported.

In some embodiments of this application, different situations indicated by the foregoing first information may be understood as different detection results.

Step 201a8: The electronic device determines that the switching between the VoWi-Fi service and the VoNR service is not supported when the first information indicates that the first operator currently used by the electronic device is not the operator that supports the switching between the VoWi-Fi service and the VoNR service and the first cell currently camped on by the electronic device is the cell that does not support the switching between the VoWi-Fi service and the VoNR service.

For example, when the foregoing detection result is that the first operator currently used by the electronic device is not the operator that supports the switching between the VoWi-Fi service and the VoNR service and the first cell currently camped on by the electronic device is the cell that does not support the switching between the VoWi-Fi service and the VoNR service, the electronic device determines that the switching between the VoWi-Fi service and the VoNR service is not supported.

Step 201a9: The electronic device determines that the switching between the VoWi-Fi service and the VoNR service is not supported when the first information indicates that the first operator currently used by the electronic device is the operator that supports the switching between the VoWi-Fi service and the VoNR service and the first cell currently camped on by the electronic device is the cell that does not support the switching between the VoWi-Fi service and the VoNR service.

For example, when the foregoing detection result is that the first operator currently used by the electronic device is the operator that supports the switching between the VoWi-Fi service and the VoNR service and the first cell currently camped on by the electronic device is the cell that does not support the switching between the VoWi-Fi service and the VoNR service, the electronic device determines that the switching between the VoWi-Fi service and the VoNR service is not supported.

In some embodiments of this application, when the electronic device camps on the first cell, the electronic device may obtain the first cell information in advance, determine, based on the first cell information and the cell information of the first cell, whether the switching between the VoWi-Fi service and the VoNR service is supported, and save the result. Then, the electronic device may directly determine, during transmission of the first voice service corresponding to the first call by the electronic device through the first network, whether the switching between the VoWi-Fi service and the VoNR service is supported based on the foregoing result.

In this way, the electronic device may determine, based on the first operator information and the first cell information, whether the switching between the VoWi-Fi service and the VoNR service is supported. Therefore, flexibility and diversity of determining, by the electronic device, whether the switching between the VoWi-Fi service and the VoNR service is supported are improved.

Step 202: The electronic device switches to a second network when the switching between the VoWi-Fi service and the VoNR service is supported, and transmits the first voice service through the second network.

The foregoing second network is a Wi-Fi network or a 5G network, and the first network is different from the second network.

It may be understood that when the first network is the Wi-Fi network, the second network is the 5G network. During transmission of the first voice service corresponding to the first call by the electronic device through the Wi-Fi network, the electronic device switches to the 5G network and transmits the first voice service through the 5G network if the switching between the VoWi-Fi service and the VoNR service is supported.

It may be understood that when the first network is the 5G network, the second network is the Wi-Fi network. During transmission of the first voice service corresponding to the first call by the electronic device through the 5G network, the electronic device switches to the Wi-Fi network and transmits the first voice service through the Wi-Fi network if the switching between the VoWi-Fi service and the VoNR service is supported.

In some embodiments of this application, when that the switching between the VoWi-Fi service and the VoNR service is supported is determined, the electronic device may preset a network switching sequence. Therefore, the electronic device may switch the network based on the preset network switching sequence during transmission of the voice service by the electronic device based on the network, and continue to transmit the voice service based on the network after the switching.

For example, the network switching sequence is set as: the Wi-Fi network>the 5G network>the 4G network.

In some embodiments of this application, "the electronic device switches to a second network" in step 202 above may be implemented through step 202a or step 202b above.

Step 202a: The electronic device switches to the second network when network quality of the first network satisfies a predetermined condition.

The foregoing first network is the Wi-Fi network, and the second network is the 5G network.

In some embodiments of this application, the switching, by the electronic device, to the second network and transmitting the first voice service through the second network may be understood as switching, by the electronic device, to transmit the VoNR service through the 5G network during transmitting the VoWi-Fi service through the Wi-Fi network. It should be noted that the foregoing first voice service includes the VoWi-Fi service and the VoNR service herein. In other words, transmission of the first voice service is not interrupted, namely, the first call of the electronic device is not interrupted.

It may be understood that during transmission of the first voice service corresponding to the first call by the electronic device through the Wi-Fi network and when the switching between the VoWi-Fi service and the VoNR service is supported, the electronic device switches to the 5G network and transmits the first voice service through the 5G network if the electronic device moves to an area with a relatively poor Wi-Fi network or weak coverage of the Wi-Fi network.

In some embodiments of this application, when the network quality of the Wi-Fi network does not satisfy the predetermined condition, the electronic device continues to transmit the first voice service corresponding to the first call through the Wi-Fi network.

Step 202b: The electronic device switches to the second network when the electronic device establishes a network connection to the second network.

The foregoing first network is the 5G network, and the second network is the Wi-Fi network.

In some embodiments of this application, that the electronic device establishes a network connection to the second network may be understood as that the electronic device is registered with the second network, but cannot use the second network in this case.

It may be understood that during transmission of the first voice service corresponding to the first call by the electronic device through the 5G network, the electronic device is pre-connected to the Wi-Fi network if the electronic device moves into a coverage area of the Wi-Fi network. In addition, because the switching between the VoWi-Fi service and the VoNR service is supported, the electronic device may switch to the Wi-Fi network and transmit the first voice service through the Wi-Fi network.

In some embodiments of this application, when the electronic device does not establish the network connection to the Wi-Fi network, namely, the electronic device does not enter the coverage area of the Wi-Fi network, the electronic device continues to transmit the first voice service corresponding to the first call through the 5G network.

In this way, it is determined that the switching between the VoWi-Fi service and the VoNR service is supported, so that during transmission of the first voice service by the electronic device through the Wi-Fi network and when the network quality of the Wi-Fi network satisfies the predetermined condition, the electronic device switches to the 5G network to continue to transmit the first voice service. Alternatively, in the process in which the electronic device transmits the first voice service through the 5G network, and establishes the network connection to the Wi-Fi network, the electronic device switches to the Wi-Fi network to continue to transmit the first voice service, thereby avoiding that the electronic device randomly switches between networks during transmission of the first voice service by the electronic device through the Wi-Fi network or the 5G network, causing interruption of the call of the electronic device. Therefore, call integrity of the electronic device is improved, thereby improving call efficiency.

In some embodiments of this application, when the switching between the VoWi-Fi service and the VoNR service is supported, the network switching method provided in this embodiment of this application may further include step 401 or step 402 below.

Step 401: The electronic device adds, to the first cell information when the switching from the first network to the second network fails, cell information of a second cell currently camped on by the electronic device.

The foregoing first network is the 5G network, and the second network is the Wi-Fi network.

It may be understood that when the second cell currently camped on by the electronic device is a cell to which the electronic device camps for the first time, the electronic device does not determine whether the second cell is the cell that does not support the switching between the VoWi-Fi service and the VoNR service. Therefore, the foregoing first cell information does not include the cell information of the second cell, and the electronic device may consider that the second cell is not the cell that does not support the switching between the VoWi-Fi service and the VoNR service. In other words, the electronic device considers that the second cell supports the switching between the VoWi-Fi service and the VoNR service, and performs switching. If the actual switching fails, the electronic device determines that the second cell is the cell that does not support the switching between the VoWi-Fi service and the VoNR service, and adds the cell information of the second cell to the first cell information.

In some embodiments of this application, when switching from the first network to the second network fails, the electronic device may mark the second cell as the cell that does not support the switching between the VoWi-Fi service and the VoNR service, and store marking information.

In some embodiments of this application, when the electronic device camps on the second cell again, the electronic device may determine, based on the cell information of the second cell included in the first cell information or the marking information, that the switching between the VoWi-Fi service and the VoNR service is not supported.

In this way, when the switching from the first network to the second network fails, the cell information of the second cell currently camped on by the electronic device is added to the foregoing first cell information. Therefore, when the electronic device subsequently camps on the second cell again, the electronic device can determine, based on the cell information of the second cell that is included in the first cell information, that the switching between the VoWi-Fi service and the VoNR service is not supported, thereby improving the call efficiency of the electronic device.

Step 402: The electronic device adds, to the first cell information when the switching from the first network to the second network fails, cell information of a third cell on which the electronic device fails to camp successfully.

The foregoing first network is the Wi-Fi network, and the second network is the 5G network.

It may be understood that during transmission of the VoWi-Fi service by the electronic device through the Wi-Fi network, the electronic device may switch to the 5G network if the electronic device moves to the area with a relatively poor Wi-Fi network or weak coverage of the Wi-Fi network, to continue to transmit the first voice service through the 5G network. If the electronic device is successfully switched, the electronic device camps on to the third cell. Because the third cell is a cell to which the electronic device has not camped, the electronic device does not determine whether the third cell is the cell that does not support the switching between the VoWi-Fi service and the VoNR service. Therefore, the first cell information does not include the cell information of the third cell. The electronic device may consider that the third cell supports the switching between the VoWi-Fi service and the VoNR service, and performs the switching. If the actual switching fails, it indicates that the third cell on which the electronic device fails to camp successfully is the cell that does not support the switching between the VoWi-Fi service and the VoNR service. The electronic device may add the cell information of the third cell to the foregoing first cell information.

In this way, when the switching from the first network to the second network fails, the cell information of the third cell on which the electronic device fails to camp successfully is added to the foregoing first cell information. Therefore, when the electronic device needs to subsequently camp on the third cell, the electronic device may determine, based on the cell information of the third cell that is included in the first cell information, that the switching between the VoWi-Fi service and the VoNR service is not supported, thereby improving the call efficiency of the electronic device.

Step 203: The electronic device switches to a third network when the switching between the VoWi-Fi service and the VoNR service is not supported, and transmits the first voice service through the third network.

The third network is different from the first network, and the third network is different from the second network.

In some embodiments of this application, the foregoing third network may be any one of the following: a second generation mobile communication technology (2-Generation wireless telephone technology, 2G), a third generation mobile communication technology (3G), or a fourth generation mobile communication technology (4G), which is not limited in this embodiment of this application.

It may be understood that during transmission of the first voice service corresponding to the first call by the electronic device through the Wi-Fi network or the 5G network, the electronic device switches to the third network and transmits the first voice service through the third network if the switching between the VoWi-Fi service and the VoNR service is not supported.

It may be understood that a switching technology between the third network and the Wi-Fi network is relatively mature. Therefore, the third network may be switched to continue to transmit the first voice service.

In some embodiments of this application, that the electronic device transmits the first voice service through the third network may be understood as that in a process of transmitting the VoWi-Fi service through the Wi-Fi network or transmitting the VoNR service through the 5G network, the electronic device switches to transmit the VoLTE service through the third network (for example, a 4G network). It should be noted that the foregoing first voice service includes the VoWi-Fi service and the VoLTE service herein, or includes the VoNR service and the VoLTE service herein. In other words, the transmission of the first voice service is not interrupted, namely, the first call of the electronic device is not interrupted.

In some embodiments of this application, when it is determined that the switching between the VoWi-Fi service and the VoNR service is not supported, the electronic device may preset the network switching sequence. Therefore, the electronic device can switch the network based on the preset network switching sequence during transmission of the voice service by the electronic device based on the network, and continue to transmit the voice service based on the network after the switching.

For example, the user may define the network switching sequence as: the 5G network>the 4G network>the Wi-Fi network, or the Wi-Fi network>the 4G network>the 5G network, to avoid direct switching between the 5G network and the Wi-Fi network.

In some embodiments of this application, "the electronic device switches to a third network" in step 203 above may be implemented through step 203a or step 203b below.

Step 203a: The electronic device switches to the third network when the network quality of the first network satisfies the predetermined condition.

The foregoing first network is the Wi-Fi network, and the second network is the 5G network.

It may be understood that during transmission of the first voice service corresponding to the first call by the electronic device through the Wi-Fi network and when the switching between the VoWi-Fi service and the VoNR service is supported, the electronic device switches to the third network and transmits the first voice service through the third network if the electronic device moves to the area with a relatively poor Wi-Fi network or weak coverage of the Wi-Fi network.

In some embodiments of this application, after switching to the third network, the electronic device may then switch from the third network to the 5G network, to transmit the first voice service through the 5G network.

Step 203b: The electronic device switches to the third network when the electronic device establishes the network connection to the second network.

The foregoing first network is the 5G network, and the second network is the Wi-Fi network.

It may be understood that during transmission of the first voice service corresponding to the first call by the electronic device through the 5G network, the electronic device is pre-connected to the Wi-Fi network if the electronic device moves to the Wi-Fi network. However, because the switching between the VoWi-Fi service and the VoNR service is not supported, the electronic device switches to the third network, and transmits the first voice service through the third network.

In some embodiments of this application, after switching to the third network, the electronic device may then switch from the third network to the Wi-Fi network, to transmit the first voice service through the Wi-Fi network.

In this way, it is determined that the switching between the VoWi-Fi service and the VoNR service is not supported, so that during transmission of the first voice service by the electronic device through the Wi-Fi network and when the network quality of the Wi-Fi network satisfies the predetermined condition, the electronic device switches to the third network to continue to transmit the first voice service. Alternatively, in the process in which the electronic device transmits the first voice service through the 5G network, and establishes the network connection to the Wi-Fi network, the electronic device switches to the third network to continue to transmit the first voice service, thereby avoiding that the call of the electronic device is interrupted during transmission of the first voice service by the electronic device through the Wi-Fi network or the 5G network and when the switching between the VoWi-Fi service and the VoNR service is not supported. Therefore, flexibility of transmitting the voice service by the electronic device is improved, thereby improving the call efficiency of the electronic device.

In some embodiments of this application, the user may define a priority order of the VoNR, the VoLTE, and the VoWi-Fi on a call setting interface of the electronic device. It may be understood that, after the user defines the priority order of the VoNR, the VoLTE, and the VoWi-Fi, the electronic device may make a call in a network order corresponding to the priority order when making a call.

For example, for an operator that does not support switching between the VoNR and the VoWi-Fi, the user may define a call priority order as the VoNR>the VoLTE>the VoWi-Fi or the VoWi-Fi>the VoLTE>the VoNR, to avoid direct switching between the VoNR and the VoWi-Fi. That the VoNR>the VoLTE>the VoWi-Fi indicates that the electronic device preferentially selects the VoNR, but does not register the VoWi-Fi in priority when the Wi-Fi is connected, and registers the VoLTE first. That the VoWi-Fi>the VoLTE>the VoNR represents that the electronic device preferentially selects the VoWi-Fi, but does not register the VoNR in priority in a coverage area of an NR network, and registers the VoLTE first. If the user sets the VoLTE only, the user registers only the VoLTE for a call.

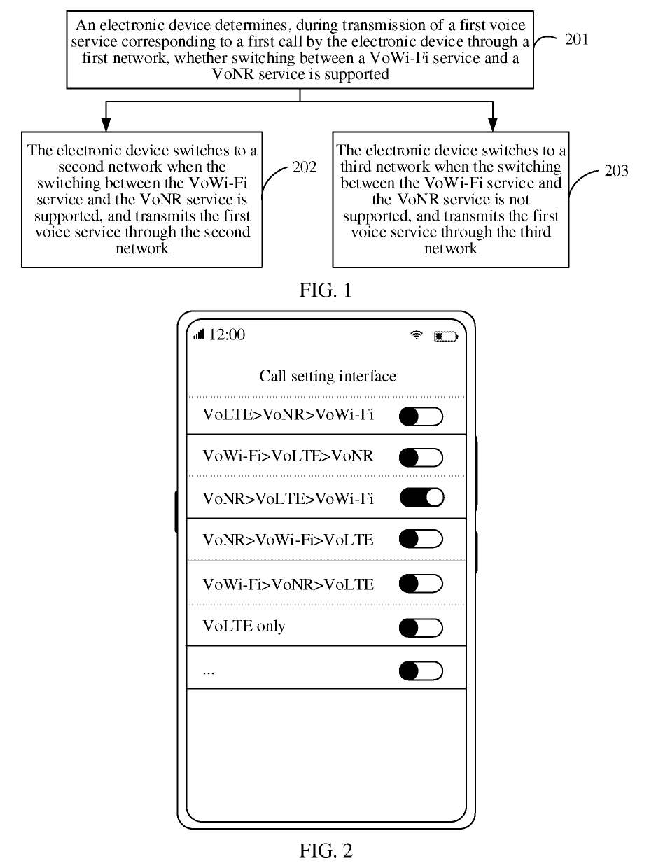

For example, FIG. 2 shows a call setting interface of an electronic device. The interface includes a plurality of call priority orders. A user may select at least one to open, so that the user makes a call based on the selected call priority order when the electronic device makes a call.

In the network switching method provided in this embodiment of this application, the electronic device may determine, during transmission of a first voice service corresponding to a first call by the electronic device through a first network, whether the switching between the VoWi-Fi service and the VoNR service is supported. As a result, when a determining result is that the switching between the VoWi-Fi service and the VoNR service is supported, the electronic device may switch from the Wi-Fi network to the 5G network or switch from the 5G network to the Wi-Fi network. However, when the determining result is that the switching between the VoWi-Fi service and the VoNR service is not supported, the electronic device may switch from the Wi-Fi network or the 5G network to another third network. It is avoided that during transmission of the first voice service by the electronic device through the Wi-Fi network or the 5G network and when the electronic device needs to switch a network and attempts to switch between the first network and the second network, a problem of call interruption caused by failed network switching of the electronic device is caused because the electronic device does not support the switching between the VoWi-Fi service and the VoNR service. Therefore, flexibility of transmitting a voice service by the electronic device is improved, thereby improving call continuity of the electronic device.

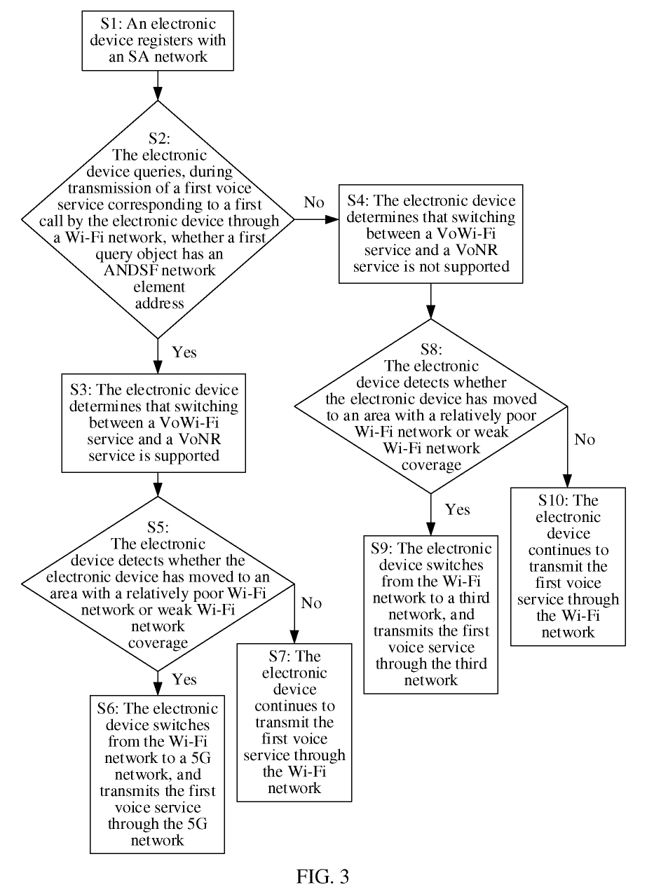

In some embodiments of this application, as shown in FIG. 3, the network switching method provided in embodiments of this application may include step S1 to step S10 below.

Step S1: An electronic device registers with an SA network.

Step S2: The electronic device queries, during transmission of a first voice service corresponding to a first call by the electronic device through a Wi-Fi network, whether a first query object has an ANDSF network element address.

If yes, step S3 is performed. If no, step S4 is performed.

Step S3: The electronic device determines that switching between the VoWi-Fi service and the VoNR service is supported.

Step S4: The electronic device determines that switching between the VoWi-Fi service and the VoNR service is not supported.

After step S3, the electronic device performs steps S5-S7.

Step S5: The electronic device detects whether the electronic device has moved to an area with a relatively poor Wi-Fi network or weak Wi-Fi network coverage.

It may be understood that, the electronic device detects whether network quality of the first network satisfies a predetermined condition.

If yes, step S6 is performed. If no, step S7 is performed.

Step S6: The electronic device switches from the Wi-Fi network to a 5G network, and transmits the first voice service through the 5G network.

Step S7: The electronic device continues to transmit the first voice service through the Wi-Fi network.

After step S4, the electronic device performs steps S8-S10.

Step S8: The electronic device detects whether the electronic device has moved to an area with a relatively poor Wi-Fi network or weak Wi-Fi network coverage.

If yes, step S9 is performed. If no, step S10 is performed.

Step S9: The electronic device switches from the Wi-Fi network to a third network, and transmits the first voice service through the third network.

Step S10: The electronic device continues to transmit the first voice service through the Wi-Fi network.

It should be noted that for related descriptions of step S1 to step S10, reference may be made to content in the foregoing embodiment. Details are not described herein again.

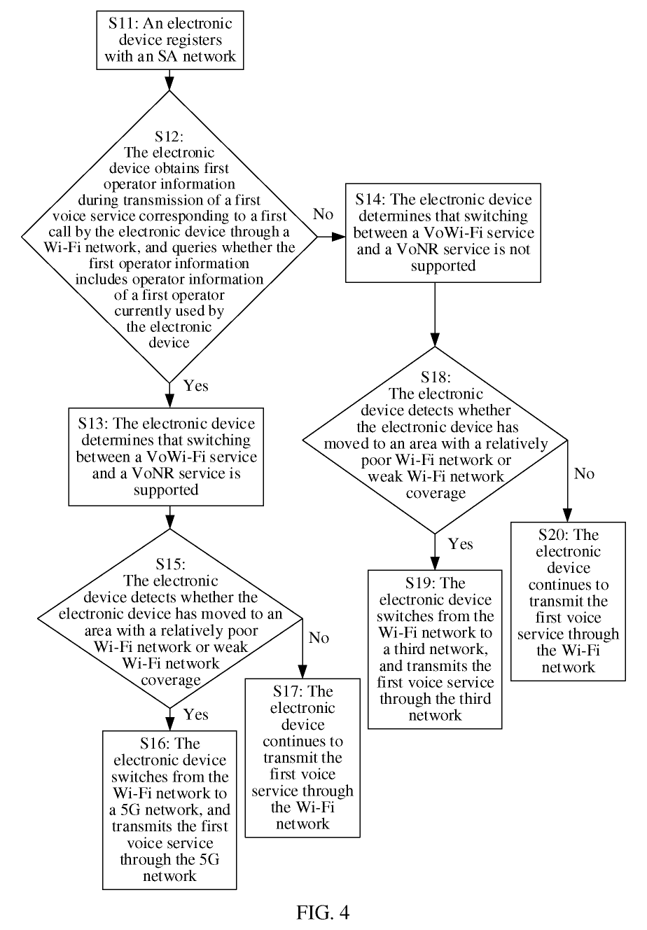

In some embodiments of this application, as shown in FIG. 4, the network switching method provided in embodiments of this application may include step S11 to step S20 below.

Step S11: An electronic device registers with an SA network.

Step S12: The electronic device obtains first operator information during transmission of a first voice service corresponding to a first call by the electronic device through a Wi-Fi network, and queries whether the first operator information includes operator information of a first operator currently used by the electronic device.

If yes, step S13 is performed. If no, step S14 is performed.

Step S13: The electronic device determines that switching between a VoWi-Fi service and a VoNR service is supported.

Step S14: The electronic device determines that switching between a VoWi-Fi service and a VoNR service is not supported.

After step S13, the electronic device performs steps S15-S17.

Steps S15-S17 are the same as steps S5-S7 above.

After step S14, the electronic device performs steps S18-S20.

Steps S18-S20 are the same as steps S8-S10 above.

It should be noted that for related descriptions of step S11 to step S20, reference may be made to content in the foregoing embodiment. Details are not described herein again.

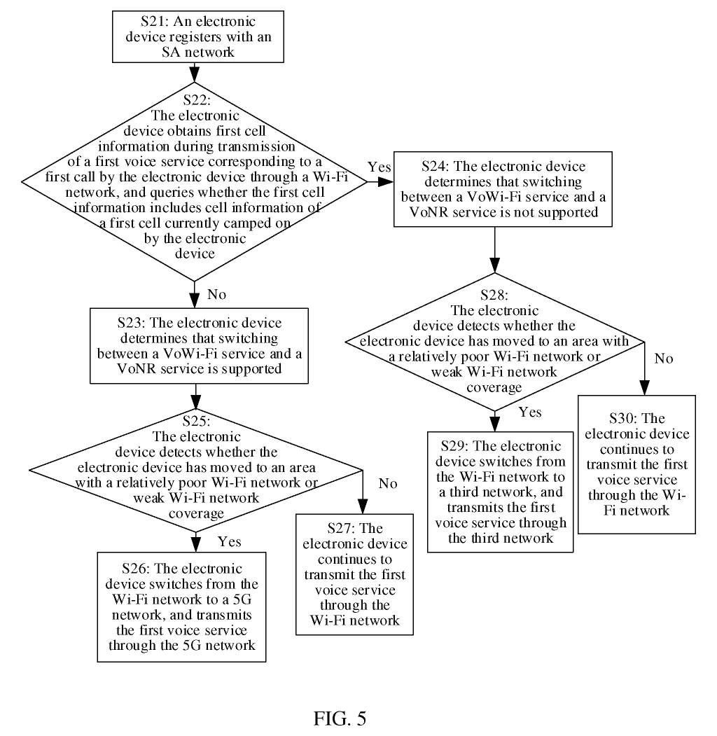

In some embodiments of this application, as shown in FIG. 5, the network switching method provided in embodiments of this application may include step S21 to step S30 below.

Step S21: An electronic device registers with an SA network.

Step S22: The electronic device obtains first cell information during transmission of a first voice service corresponding to a first call by the electronic device through a Wi-Fi network, and queries whether the first cell information includes cell information of a first cell currently camped on by the electronic device.

If no, step S23 is performed. If yes, step S24 is performed.

Step S23: The electronic device determines that the switching between a VoWi-Fi service and a VoNR service is supported.

Step S24: The electronic device determines that the switching between a VoWi-Fi service and a VoNR service is not supported.

After step S23, the electronic device performs steps S25-S27.

Steps S25-S27 are the same as steps S5-S7 above.

After step S24, the electronic device performs steps S28-S30.

Steps S28-S30 are the same as steps S8-S10 above.

It should be noted that for related descriptions of step S21 to step S30, reference may be made to content in the foregoing embodiment. Details are not described herein again.

It should be noted that the network switching method provided in this embodiment of this application may be performed by a network switching apparatus. In this embodiment of this application, the network switching apparatus provided in this embodiment of this application is described by using an example in which the network switching apparatus performs the network switching method.

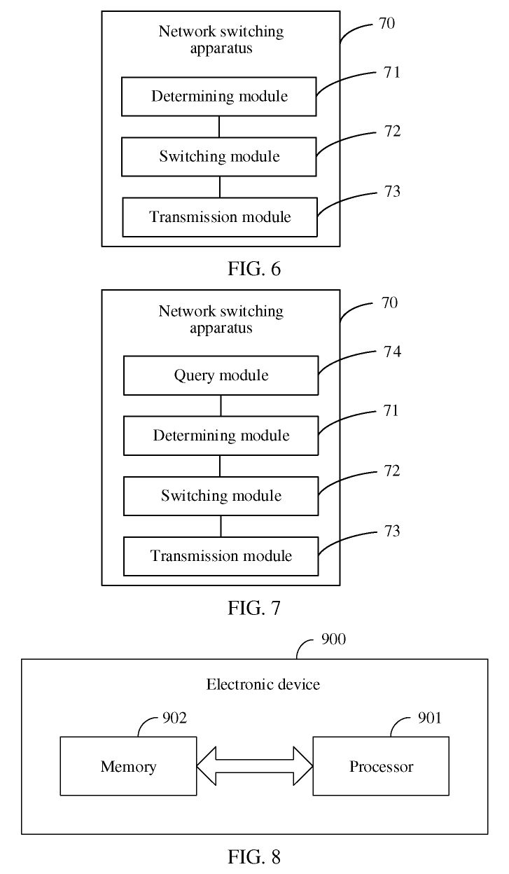

FIG. 6 is a possible schematic structural diagram of a network switching apparatus involved in an embodiment of this application. As shown in FIG. 6, the network switching apparatus 70 may include a determining module 71, a switching module 72, and a transmission module 73.

The determining module 71 is configured to determine, during transmission of a first voice service corresponding to a first call by an electronic device through a first network, whether switching between a VoWi-Fi service and a VoNR service is supported, where the first network is a Wi-Fi network or a 5G network. The switching module 72 is configured to switch to a second network when the determining module 71 determines that the switching between the VoWi-Fi service and the VoNR service is supported. The transmission module 73 is configured to transmit the first voice service through the second network after the switching module 72 switches to the second network, the second network is the Wi-Fi network or the 5G network, and the first network is different from the second network. The switching module 72 is further configured to switch to a third network when the determining module 71 determines that the switching between the VoWi-Fi service and the VoNR service is not supported. The transmission module 73 is further configured to transmit the first voice service through the third network after the switching module 72 switches to the second network, the third network is different from the first network, and the third network is different from the second network.

In the network switching apparatus provided in this embodiment of this application, the network switching apparatus may determine, during transmission of a first voice service corresponding to a first call by the network switching apparatus through a first network, whether the switching between the VoWi-Fi service and the VoNR service is supported. As a result, when a determining result is that the switching between the VoWi-Fi service and the VoNR service is supported, the network switching apparatus may switch from the Wi-Fi network to the 5G network or switch from the 5G network to the Wi-Fi network. However, when the determining result is that the switching between the VoWi-Fi service and the VoNR service is not supported, the network switching apparatus may switch from the Wi-Fi network or the 5G network to another third network. It is avoided that during transmission of the first voice service by the network switching apparatus through the Wi-Fi network or the 5G network and when the network switching apparatus needs to switch a network and attempts to switch between the first network and the second network, a problem of call interruption caused by failed network switching of the network switching apparatus is caused because the network switching apparatus does not support the switching between the VoWi-Fi service and the VoNR service. Therefore, flexibility of transmitting a voice service by the network switching apparatus is improved, thereby improving call continuity of the network switching apparatus.

In a possible implementation, the foregoing determining module 71 is configured to determine, based on first information, whether the switching between the VoWi-Fi service and the VoNR service is supported, and the first information is any one of the following: relevant information of an ANDSF network element address, first operator information of an operator that supports the switching between the VoWi-Fi service and the VoNR service, and first cell information of a cell that does not support the switching between the VoWi-Fi service and the VoNR service.

In a possible implementation, the foregoing first information includes the relevant information of the ANDSF network element address. With reference to FIG. 6, as shown in FIG. 7, the network switching apparatus 70 provided in this embodiment of this application further includes a query module 74. The query module 74 is further configured to query a first query object for the ANDSF network element address and use a query result as the first information before the foregoing determining module 71 determines, based on the first information, whether the switching between the VoWi-Fi service and the VoNR service is supported.

The foregoing determining module 71 is configured to:

determine that the switching between the VoWi-Fi service and the VoNR service is supported if the query result indicates that the ANDSF network element address is found in the first query object; or

determine that the switching between the VoWi-Fi service and the VoNR service is not supported if the query result indicates that the ANDSF network element address is not found in the first query object.

In a possible implementation, the foregoing first information includes the operator information. The foregoing determining module 71 is configured to:

determine that the switching between the VoWi-Fi service and the VoNR service is supported when the first information indicates that a first operator currently used by the electronic device is the operator that supports the switching between the VoWi-Fi service and the VoNR service; or

determine that the switching between the VoWi-Fi service and the VoNR service is not supported when the first information indicates that the first operator currently used by the electronic device is not the operator that supports the switching between the VoWi-Fi service and the VoNR service.

In a possible implementation, the foregoing first information includes the cell information. The foregoing determining module 71 is configured to:

determine that the switching between the VoWi-Fi service and the VoNR service is supported when the first information indicates that a first cell currently camped on by the electronic device is not the cell that does not support the switching between the VoWi-Fi service and the VoNR service; or

determine that the switching between the VoWi-Fi service and the VoNR service is not supported when the first information indicates that the first cell currently camped on by the electronic device is the cell that does not support the switching between the VoWi-Fi service and the VoNR service.

In a possible implementation, the foregoing first information includes the operator information and the cell information. The foregoing determining module 71 is configured to:

determine that the switching between the VoWi-Fi service and the VoNR service is supported when the first information indicates that a first cell currently camped on by the electronic device is not the cell that does not support the switching between the VoWi-Fi service and the VoNR service; or

determine that the switching between the VoWi-Fi service and the VoNR service is not supported when the first information indicates that a first operator currently used by the electronic device is not the operator that supports the switching between the VoWi-Fi service and the VoNR service, and that a first cell currently camped on by the electronic device is the cell that does not support the switching between the VoWi-Fi service and the VoNR service; or

determine that the switching between the VoWi-Fi service and the VoNR service is not supported when the first information indicates that the first operator currently used by the electronic device is the operator that supports the switching between the VoWi-Fi service and the VoNR service, and that the first cell currently camped on by the electronic device is the cell that does not support the switching between the VoWi-Fi service and the VoNR service.

In a possible implementation, the network switching apparatus 70 provided in this embodiment of this application further includes an addition module. When the switching between the VoWi-Fi service and the VoNR service is supported, the addition module is configured to:

add, to the first cell information when the switching from the first network to the second network fails, cell information of a second cell currently camped on by the electronic device, where the first network is the 5G network, and the second network is the Wi-Fi network; or

add, to the first cell information when the switching from the first network to the second network fails, cell information of a third cell on which the electronic device fails to camp successfully, where the first network is the Wi-Fi network, and the second network is the 5G network.

The network switching apparatus in embodiments of this application may be an electronic device, or may be a component in the electronic device, for example, an integrated circuit or a chip. The electronic device may be a terminal, or may be another device other than the terminal. For example, the electronic device may be a mobile phone, a tablet computer, a notebook computer, a palmtop computer, an on-board electronic device, a mobile internet device (MID), an augmented reality (AR)/virtual reality (VR) device, a robot, a wearable device, an ultra-mobile personal computer (UMPC), a netbook, or a personal digital assistant (PDA); or may be a server, a network attached storage (NAS), a personal computer (PC), a television (TV), a teller machine, or a self-service machine, which is not limited in embodiments of this application.

The network switching apparatus in this embodiment of this application may be an apparatus having an operating system. The operating system may be Android, iOS, or another possible operating system, which is not defined in this embodiment of this application.

The network switching apparatus provided in this embodiment of this application can implement all processes implemented in the foregoing method embodiments. To avoid repetition, details are not described herein again.

Optionally, as shown in FIG. 8, an embodiment of this application further provides an electronic device 900, including a processor 901 and a memory 902. The memory 902 stores a program or an instruction executable on the processor 901. The program or the instruction, when executed by the processor 901, implements the steps of the foregoing method embodiments, and can achieve the same technical effect. To avoid repetition, details are not described herein again.

It should be noted that the electronic device in this embodiment of this application includes both the mobile electronic device and the non-mobile electronic device described above.

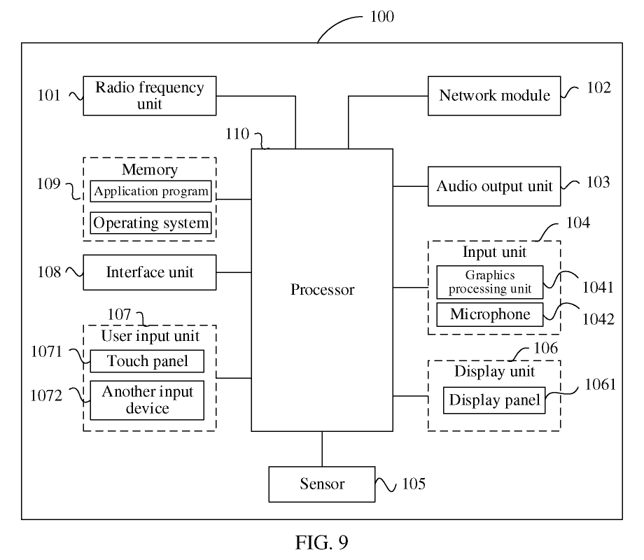

FIG. 9 is a schematic diagram of a hardware structure of an electronic device for implementing an embodiment of this application.

The electronic device 100 includes, but is not limited to, components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that the electronic device 100 may further include a power supply (such as a battery) for supplying power to the components. The power supply may be logically connected to the processor 110 through a power management system, thereby implementing functions such as charging, discharging, and power consumption management through the power management system. The electronic device structure shown in FIG. 9 constitutes no limitation on an electronic device, and the electronic device may include more or fewer components than those shown in the figure, or some merged components, or different component arrangements. Details are not described herein again.

The processor 110 is configured to: determine, during transmission of a first voice service corresponding to a first call by an electronic device through a first network, whether switching between a VoWi-Fi service and a VoNR service is supported, where the first network is a Wi-Fi network or a 5G network; switch to a second network when the determining module determines that the switching between the VoWi-Fi service and the VoNR service is supported; transmit the first voice service through the second network, where the second network is the Wi-Fi network or the 5G network, and the first network is different from the second network; switch to a third network when it is determined that the switching between the VoWi-Fi service and the VoNR service is not supported; and transmit the first voice service through the third network, where the third network is different from the first network, and the third network is different from the second network.

An embodiment of this application provides an electronic device. The electronic device may determine, during transmission of a first voice service corresponding to a first call by the electronic device through a first network, whether the switching between the VoWi-Fi service and the VoNR service is supported. As a result, when a determining result is that the switching between the VoWi-Fi service and the VoNR service is supported, the electronic device may switch from the Wi-Fi network to the 5G network or switch from the 5G network to the Wi-Fi network. However, when the determining result is that the switching between the VoWi-Fi service and the VoNR service is not supported, the electronic device may switch from the Wi-Fi network or the 5G network to another third network. It is avoided that during transmission of the first voice service by the electronic device through the Wi-Fi network or the 5G network and when the electronic device needs to switch a network and attempts to switch between the first network and the second network, a problem of call interruption caused by failed network switching of the electronic device is caused because the electronic device does not support the switching between the VoWi-Fi service and the VoNR service. Therefore, flexibility of transmitting a voice service by the electronic device is improved, thereby improving call continuity of the electronic device.

In some embodiments of this application, the processor 110 is configured to determine, based on first information, whether the switching between the VoWi-Fi service and the VoNR service is supported, and the first information is any one of the following: relevant information of an ANDSF network element address, first operator information of an operator that supports the switching between the VoWi-Fi service and the VoNR service, and first cell information of a cell that does not support the switching between the VoWi-Fi service and the VoNR service.

In some embodiments of this application, the foregoing first information includes the relevant information of the ANDSF network element address. The processor 110 is further configured to query a first query object for the access network discovery and selection function ANDSF network element address and use a query result as the first information before it is determined, based on the first information, whether the switching between the VoWi-Fi service and the VoNR service is supported.

The processor 110 is configured to:

determine that the switching between the VoWi-Fi service and the VoNR service is supported if the query result indicates that the ANDSF network element address is found in the first query object; or

determine that the switching between the VoWi-Fi service and the VoNR service is not supported if the query result indicates that the ANDSF network element address is not found in the first query object.

In some embodiments of this application, the foregoing first information includes the operator information. The foregoing processor 110 is configured to:

determine that the switching between the VoWi-Fi service and the VoNR service is supported when the first information indicates that a first operator currently used by the electronic device is the operator that supports the switching between the VoWi-Fi service and the VoNR service; or

determine that the switching between the VoWi-Fi service and the VoNR service is not supported when the first information indicates that the first operator currently used by the electronic device is not the operator that supports the switching between the VoWi-Fi service and the VoNR service.

In some embodiments of this application, the foregoing first information includes the cell information. The foregoing processor 110 is configured to:

determine that the switching between the VoWi-Fi service and the VoNR service is supported when the first information indicates that a first cell currently camped on by the electronic device is not the cell that does not support the switching between the VoWi-Fi service and the VoNR service; or

determine that the switching between the VoWi-Fi service and the VoNR service is not supported when the first information indicates that the first cell currently camped on by the electronic device is the cell that does not support the switching between the VoWi-Fi service and the VoNR service.

In some embodiments of this application, the foregoing first information includes the operator information and the cell information. The foregoing processor 110 is configured to:

determine that the switching between the VoWi-Fi service and the VoNR service is supported when the first information indicates that a first cell currently camped on by the electronic device is not the cell that does not support the switching between the VoWi-Fi service and the VoNR service; or

determine that the switching between the VoWi-Fi service and the VoNR service is not supported when the first information indicates that a first operator currently used by the electronic device is not the operator that supports the switching between the VoWi-Fi service and the VoNR service, and that a first cell currently camped on by the electronic device is the cell that does not support the switching between the VoWi-Fi service and the VoNR service; or

determine that the switching between the VoWi-Fi service and the VoNR service is not supported when the first information indicates that the first operator currently used by the electronic device is the operator that supports the switching between the VoWi-Fi service and the VoNR service, and that the first cell currently camped on by the electronic device is the cell that does not support the switching between the VoWi-Fi service and the VoNR service.

In some embodiments of this application, when the switching between the VoWi-Fi service and the VoNR service is supported, the processor 110 is further configured to:

add, to the first cell information when the switching from the first network to the second network fails, cell information of a second cell currently camped on by the electronic device, where the first network is the 5G network, and the second network is the Wi-Fi network; or

add, to the first cell information when the switching from the first network to the second network fails, cell information of a third cell on which the electronic device fails to camp successfully, where the first network is the Wi-Fi network, and the second network is the 5G network.

The electronic device provided in embodiments of this application can implement the processes implemented in the foregoing method embodiments, and can achieve the same technical effect. To avoid repetition, details are not described herein again.

For beneficial effects of various implementations in this embodiment, refer to the beneficial effects of the corresponding implementations in the foregoing method embodiments. In order to avoid repetition, details are not described herein gain.

It should be noted that in this embodiment of this application, the input unit 104 may include a graphics processing unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061. The display panel 1061 may be configured in a form such as a liquid crystal display or an organic light-emitting diode. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a function button (for example, a volume control button or a power button), a trackball, a mouse, and a joystick. Details are not described herein again.

The memory 109 may be configured to store a software program and various data. The memory 109 may include mainly a first storage area for storing a program or instructions and a second storage area for storing data. The first storage area may store an operating system, an application program or an instruction required for at least one function (for example, a sound playback function and an image playback function), and the like. In addition, the memory 109 may include a volatile memory or a non-volatile memory, or the memory 109 may include both the volatile memory and the non-volatile memory. The non-transitory memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM). The memory 109 in embodiments of this application includes, but is not limited to these memories and any other memories of suitable types.

The processor 110 may include one or more processing units. Optionally, the processor 110 integrates an application processor and a modem processor. The application processor mainly processes operations related to an operating system, a user interface, an application program, and the like. The modem processor mainly processes wireless communication signals, and is, for example, a baseband processor. It may be understood that the foregoing modem processor may alternatively not be integrated into the processor 110.

An embodiment of this application further provides a non-transitory readable storage medium. The non-transitory readable storage medium stores a program or an instruction. When the program or the instruction is executed by a processor, the processes of the foregoing method embodiments are implemented, and can achieve the same technical effect. To avoid repetition, details are not described herein again.

The processor is a processor in the electronic device in the foregoing embodiment. The non-transitory readable storage medium includes a non-transitory computer-readable storage medium, such as a computer read-only memory ROM, a random access memory RAM, a magnetic disk, or an optical disk.

An embodiment of this application further provides a chip. The chip includes a processor and a communication interface. The communication interface is coupled to the processor. The processor is configured to run a program or an instruction, to implement the processes of the foregoing method embodiments, and can achieve the same technical effect. To avoid repetition, details are not described herein again.

It should be understood that the chip in this embodiment of this application may also be referred to as a system level chip, a system chip, a chip system, a system on chip, or the like.

An embodiment of this application provides a computer program product. The program product is stored in a non-transitory storage medium. The program product is executed by at least one processor to implement the processes of the foregoing method embodiments, and can achieve the same technical effect. To avoid repetition, details are not described herein again.

It should be noted that in this specification, terms "comprise", "include" or any other variants herein are intended to encompass non-exclusive inclusion, so that a process, a method, an article, or an apparatus including a series of elements not only include those elements, but also includes another element not listed explicitly or includes intrinsic elements for the process, the method, the article, or the apparatus. Without any further limitation, an element defined by a phrase "include one …" does not exclude existence of an additional same element in the process, the method, the article, or the apparatus that includes the element. In addition, it should be noted that the scope of the method and the apparatus in embodiments of this application is not limited to function execution in the order shown or discussed, and may further include function execution in a substantially simultaneous manner or in the opposite order according to the functions. For example, the described method may be performed in different order from the described order, and various steps may also be added, omitted, or combined. In addition, features described with reference to some examples may be combined in another example.

According to the descriptions of the foregoing implementations, a person skilled in the art may clearly learn that the method in the foregoing embodiments may be implemented by software with a necessary universal hardware platform, or may be implemented by hardware. Based on such an understanding, the technical solutions of this application, in essence, or a part contributing to the prior art may be embodied in a form of a computer software product. The computer software product is stored in a storage medium (such as a ROM/RAM, a magnetic disk, or an optical disk), including a plurality of instructions for causing a terminal (which may be a mobile phone, a computer, a server, a network device, or the like) to perform the method in embodiments of this application.

Although embodiments of this application are described above with reference to the accompanying drawings, this application is not limited to the embodiments described above. The foregoing embodiments are illustrative but not restrictive. With the enlightenment of this application, a person of ordinary skill in the art may make many forms without departing from the concept of this application and the protection scope of the claims. These forms fall into the protection of this application.

What is claimed is:

1. A network switching method, comprising:
determining, during transmission of a first voice service corresponding to a first call by an electronic device through a first network, whether switching between a voice over wireless fidelity (VoWi-Fi) service and a voice over new radio (VoNR) service is supported, wherein the first network is a Wi-Fi network or a fifth generation mobile communication technology (5G) network;
switching to a second network when the switching between the VoWi-Fi service and the VoNR service is supported, and transmitting the first voice service through the second network, wherein the second network is the Wi-Fi network or the 5G network, and the first network is different from the second network; and
switching to a third network when the switching between the VoWi-Fi service and the VoNR service is not supported, and transmitting the first voice service through the third network, wherein the third network is different from the first network, and the third network is different from the second network.

2. The method according to claim 1, wherein the determining whether switching between a VoWi-Fi service and a VoNR service is supported comprises:
determining, based on first information, whether the switching between the VoWi-Fi service and the VoNR service is supported, wherein the first information is used to indicate whether the switching between the VoWi-Fi service and the VoNR service is supported; and
the first information is any one of the following: relevant information of an access network discovery and selection function (ANDSF) network element address, first operator information of an operator that supports the switching between the VoWi-Fi service and the VoNR service, and first cell information of a cell that does not support the switching between the VoWi-Fi service and the VoNR service.

3. The method according to claim 2, wherein the first information comprises the relevant information of the ANDSF network element address, and before the determining, based on first information, whether the switching between the VoWi-Fi service and the VoNR service is supported, the method further comprises:
querying a first query object for the ANDSF network element address, and using a query result as the first information; and
the determining, based on first information, whether the switching between the VoWi-Fi service and the VoNR service is supported comprises:
determining that the switching between the VoWi-Fi service and the VoNR service is supported if the query result indicates that the ANDSF network element address is found in the first query object; or
determining that the switching between the VoWi-Fi service and the VoNR service is not supported if the query result indicates that the ANDSF network element address is not found in the first query object, wherein
the first query object comprises at least one of the following: a universal integrated circuit card (UICC) used by the electronic device, the electronic device, a protocol data unit (PDU) session establishment acceptance message replied by a network, a domain name server (DNS) domain name server, or a dynamic host configuration protocol (DHCP) server; and
the relevant information of the ANDSF network element address comprises the query result.

4. The method according to claim 2, wherein the first information comprises the first operator information; and
the determining, based on first information, whether the switching between the VoWi-Fi service and the VoNR service is supported comprises:
determining that the switching between the VoWi-Fi service and the VoNR service is supported when the first information indicates that a first operator currently used by the electronic device is the operator that supports the switching between the VoWi-Fi service and the VoNR service; or
determining that the switching between the VoWi-Fi service and the VoNR service is not supported when the first information indicates that the first operator currently used by the electronic device is not the operator that supports the switching between the VoWi-Fi service and the VoNR service.

5. The method according to claim 2, wherein the first information comprises the first cell information; and
the determining, based on first information, whether the switching between the VoWi-Fi service and the VoNR service is supported comprises:
determining that the switching between the VoWi-Fi service and the VoNR service is supported when the first information indicates that a first cell currently camped on by the electronic device is not the cell that does not support the switching between the VoWi-Fi service and the VoNR service; or
determining that the switching between the VoWi-Fi service and the VoNR service is not supported when the first information indicates that the first cell currently camped on by the electronic device is the cell that does not support the switching between the VoWi-Fi service and the VoNR service.

6. The method according to claim 2, wherein the first information comprises the first operator information and the first cell information; and
the determining, based on first information, whether the switching between the VoWi-Fi service and the VoNR service is supported comprises:
determining that the switching between the VoWi-Fi service and the VoNR service is supported when the first information indicates that a first cell currently camped on by the electronic device is not the cell that does not support the switching between the VoWi-Fi service and the VoNR service; or
determining that the switching between the VoWi-Fi service and the VoNR service is not supported when the first information indicates that a first operator currently used by the electronic device is not the operator that supports the switching between the VoWi-Fi service and the VoNR service, and that the first cell currently camped on by the electronic device is the cell that does not support the switching between the VoWi-Fi service and the VoNR service; or
determining that the switching between the VoWi-Fi service and the VoNR service is not supported when the first information indicates that the first operator currently used by the electronic device is the operator that supports the switching between the VoWi-Fi service and the VoNR service, and that the first cell currently camped on by the electronic device is the cell that does not support the switching between the VoWi-Fi service and the VoNR service.

7. The method according to claim 2, wherein when the switching between the VoWi-Fi service and the VoNR service is supported, the method further comprises:
adding, to the first cell information when the switching from the first network to the second network fails, cell information of a second cell currently camped on by the electronic device, wherein
the first network is the 5G network, and the second network is the Wi-Fi network; or
adding, to the first cell information when the switching from the first network to the second network fails, cell information of a third cell on which the electronic device fails to camp successfully, wherein
the first network is the Wi-Fi network, and the second network is the 5G network.

8. An electronic device, comprising a processor and a memory, wherein the memory stores a program or an instruction executable on the processor, and the program or the instruction, when executed by the processor, causes the electronic device to perform:
determining, during transmission of a first voice service corresponding to a first call by the electronic device through a first network, whether switching between a voice over wireless fidelity (VoWi-Fi) service and a voice over new radio (VoNR) service is supported, wherein the first network is a Wi-Fi network or a fifth generation mobile communication (5G) network;
switching to a second network when the switching between the VoWi-Fi service and the VoNR service is supported, and transmitting the first voice service through the second network, wherein the second network is the Wi-Fi network or the 5G network, and the first network is different from the second network; and
switching to a third network when the switching between the VoWi-Fi service and the VoNR service is not supported, and transmitting the first voice service through the third network, wherein the third network is different from the first network, and the third network is different from the second network.

9. The electronic device according to claim 8, wherein the program or the instruction, when executed by the processor, causes the electronic device to perform:
determining, based on first information, whether the switching between the VoWi-Fi service and the VoNR service is supported, wherein the first information is used to indicate whether the switching between the VoWi-Fi service and the VoNR service is supported; and
the first information is any one of the following: relevant information of an access network discovery and selection function (ANDSF) network element address, first operator information of an operator that supports the switching between the VoWi-Fi service and the VoNR service, and first cell information of a cell that does not support the switching between the VoWi-Fi service and the VoNR service.

10. The electronic device according to claim 9, wherein the first information comprises the relevant information of the ANDSF network element address, and the program or the instruction, when executed by the processor, causes the electronic device to further perform:
querying a first query object for the ANDSF network element address, and using a query result as the first information; and
the program or the instruction, when executed by the processor, causes the electronic device to perform:
determining that the switching between the VoWi-Fi service and the VoNR service is supported if the query result indicates that the ANDSF network element address is found in the first query object; or
determining that the switching between the VoWi-Fi service and the VoNR service is not supported if the query result indicates that the ANDSF network element address is not found in the first query object, wherein
the first query object comprises at least one of the following: a universal integrated circuit card (UICC) used by the electronic device, the electronic device, a protocol data unit (PDU) session establishment acceptance message replied by a network, a domain name server (DNS) domain name server, or a dynamic host configuration protocol (DHCP) server; and
the relevant information of the ANDSF network element address comprises the query result.

11. The electronic device according to claim 9, wherein the first information comprises the first operator information; and
the program or the instruction, when executed by the processor, causes the electronic device to perform:
determining that the switching between the VoWi-Fi service and the VoNR service is supported when the first information indicates that a first operator currently used by the electronic device is the operator that supports the switching between the VoWi-Fi service and the VoNR service; or
determining that the switching between the VoWi-Fi service and the VoNR service is not supported when the first information indicates that the first operator currently used by the electronic device is not the operator that supports the switching between the VoWi-Fi service and the VoNR service.

12. The electronic device according to claim 9, wherein the first information comprises the first cell information; and
the program or the instruction, when executed by the processor, causes the electronic device to perform:
determining that the switching between the VoWi-Fi service and the VoNR service is supported when the first information indicates that a first cell currently camped on by the electronic device is not the cell that does not support the switching between the VoWi-Fi service and the VoNR service; or
determining that the switching between the VoWi-Fi service and the VoNR service is not supported when the first information indicates that the first cell currently camped on by the electronic device is the cell that does not support the switching between the VoWi-Fi service and the VoNR service.

13. The electronic device according to claim 9, wherein the first information comprises the first operator information and the first cell information; and
the program or the instruction, when executed by the processor, causes the electronic device to perform:
determining that the switching between the VoWi-Fi service and the VoNR service is supported when the first information indicates that a first cell currently camped on by the electronic device is not the cell that does not support the switching between the VoWi-Fi service and the VoNR service; or
determining that the switching between the VoWi-Fi service and the VoNR service is not supported when the first information indicates that a first operator currently used by the electronic device is not the operator that supports the switching between the VoWi-Fi service and the VoNR service, and that the first cell currently camped on by the electronic device is the cell that does not support the switching between the VoWi-Fi service and the VoNR service; or
determining that the switching between the VoWi-Fi service and the VoNR service is not supported when the first information indicates that the first operator currently used by the electronic device is the operator that supports the switching between the VoWi-Fi service and the VoNR service, and that the first cell currently camped on by the electronic device is the cell that does not support the switching between the VoWi-Fi service and the VoNR service.

14. The electronic device according to claim 9, wherein when the switching between the VoWi-Fi service and the VoNR service is supported, the program or the instruction, when executed by the processor, causes the electronic device to further perform:
adding, to the first cell information when the switching from the first network to the second network fails, cell information of a second cell currently camped on by the electronic device, wherein
the first network is the 5G network, and the second network is the Wi-Fi network; or
adding, to the first cell information when the switching from the first network to the second network fails, cell information of a third cell on which the electronic device fails to camp successfully, wherein
the first network is the Wi-Fi network, and the second network is the 5G network.

15. A non-transitory readable storage medium, storing a program or an instruction, wherein the program or the instruction, when executed by a processor of an electronic device, causes the electronic device to perform:
determining, during transmission of a first voice service corresponding to a first call by the electronic device through a first network, whether switching between a voice over wireless fidelity (VoWi-Fi) service and a voice over new radio (VoNR) service is supported, wherein the first network is a Wi-Fi network or a fifth generation mobile communication (5G) network;
switching to a second network when the switching between the VoWi-Fi service and the VoNR service is supported, and transmitting the first voice service through the second network, wherein the second network is the Wi-Fi network or the 5G network, and the first network is different from the second network; and
switching to a third network when the switching between the VoWi-Fi service and the VoNR service is not supported, and transmitting the first voice service through the third network, wherein the third network is different from the first network, and the third network is different from the second network.

16. The non-transitory readable storage medium according to claim 15, wherein the program or the instruction, when executed by the processor, causes the electronic device to perform:
determining, based on first information, whether the switching between the VoWi-Fi service and the VoNR service is supported, wherein the first information is used to indicate whether the switching between the VoWi-Fi service and the VoNR service is supported; and
the first information is any one of the following: relevant information of an access network discovery and selection function (ANDSF) network element address, first operator information of an operator that supports the switching between the VoWi-Fi service and the VoNR service, and first cell information of a cell that does not support the switching between the VoWi-Fi service and the VoNR service.

17. The non-transitory readable storage medium according to claim 16, wherein the first information comprises the relevant information of the ANDSF network element address, and the program or the instruction, when executed by the processor, causes the electronic device to further perform:
querying a first query object for the ANDSF network element address, and using a query result as the first information; and
the program or the instruction, when executed by the processor, causes the electronic device to perform:
determining that the switching between the VoWi-Fi service and the VoNR service is supported if the query result indicates that the ANDSF network element address is found in the first query object; or
determining that the switching between the VoWi-Fi service and the VoNR service is not supported if the query result indicates that the ANDSF network element address is not found in the first query object, wherein
the first query object comprises at least one of the following: a universal integrated circuit card (UICC) used by the electronic device, the electronic device, a protocol data unit (PDU) session establishment acceptance message replied by a network, a domain name server (DNS) domain name server, or a dynamic host configuration protocol (DHCP) server; and
the relevant information of the ANDSF network element address comprises the query result.

18. The non-transitory readable storage medium according to claim 16, wherein the first information comprises the first operator information; and
the program or the instruction, when executed by the processor, causes the electronic device to perform:
determining that the switching between the VoWi-Fi service and the VoNR service is supported when the first information indicates that a first operator currently used by the electronic device is the operator that supports the switching between the VoWi-Fi service and the VoNR service; or
determining that the switching between the VoWi-Fi service and the VoNR service is not supported when the first information indicates that the first operator currently used by the electronic device is not the operator that supports the switching between the VoWi-Fi service and the VoNR service.

19. The non-transitory readable storage medium according to claim 16, wherein the first information comprises the first cell information; and
the program or the instruction, when executed by the processor, causes the electronic device to perform:
determining that the switching between the VoWi-Fi service and the VoNR service is supported when the first information indicates that a first cell currently camped on by the electronic device is not the cell that does not support the switching between the VoWi-Fi service and the VoNR service; or
determining that the switching between the VoWi-Fi service and the VoNR service is not supported when the first information indicates that the first cell currently camped on by the electronic device is the cell that does not support the switching between the VoWi-Fi service and the VoNR service.

20. The non-transitory readable storage medium according to claim 16, wherein when the switching between the VoWi-Fi service and the VoNR service is supported, the program or the instruction, when executed by the processor, causes the electronic device to further perform:
adding, to the first cell information when the switching from the first network to the second network fails, cell information of a second cell currently camped on by the electronic device, wherein
the first network is the 5G network, and the second network is the Wi-Fi network; or
adding, to the first cell information when the switching from the first network to the second network fails, cell information of a third cell on which the electronic device fails to camp successfully, wherein
the first network is the Wi-Fi network, and the second network is the 5G network.
